(19) United States
(12) Patent Application Publication
(10) Pub. No.: US 2008/0154950 A1
(43) Pub. Date: Jun. 26, 2008

(54) Object constructors for generic frameworks

(75) Inventor: Rene Gross, Schwarzach (DE)

Correspondence Address: FISH & RICHARDSON, P.C., PO BOX 1022, MINNEAPOLIS, MN, 55440-1022, US

(73) Assignee: SAP AG, Walldorf (DE)

(21) Appl. No.: 11/643,145

(22) Filed: Dec. 21, 2006

(51) Int. Cl. G06F 7/00

(52) U.S. Cl. 707/103 R; 707/E17.055

(57) ABSTRACT

Various techniques and components are provided for software for managing object instantiation between a software application and a generic framework. In certain implementations, this allows for the instantiation of objects with an extended set of attributes, rather than merely a basic set of attributes located on the framework. In one example embodiment, the software receives a call to instantiate an object using a generic data constructor, receives a set of additional attributes for the object, and instantiates the object with the set of additional attributes. In another example embodiment, an application requests the framework to instantiate a first object using a generic class constructor. The application then transmits a first set of additional attributes for the first object to the framework receives an instantiated first object from the framework, the instantiated first object including the first set of additional attributes.

### TECHNICAL FIELD

This disclosure relates to object-oriented programming and, more particularly, to object constructors for generic frameworks.

### BACKGROUND

Software applications in object-oriented programming often require that objects of classes be instantiated with a set of attributes. Object-oriented frameworks, used to unify portions of code to reduce development and maintenance efforts, may be used to instantiate an object for a software application. In many instances, the framework may contain a basic set of class attributes for each class utilized by the application. Thus, when the application requires an instance of a particular class, the framework is called to instantiate the object with this basic set of attributes. The framework utilizes a generic data constructor to create an instance of the class. Should the software application utilize additional attributes not present in the framework, these attributes are set outside of the framework environment and constructor, when the object is available to the application. Therefore, the object attributes may not be consistent with those attributes in the software application even if the additional attributes are set immediately after object instantiation within the framework.

### SUMMARY

This disclosure provides various embodiments of software for managing object instantiation between a software application and a generic framework through, for example, a data constructor. In one implementation, the software requests the framework to instantiate an object using a generic class constructor, transmits a set of additional attributes for the object to the framework, and receives an instantiated object from the framework. The instantiated object attributes include the additional attributes sent to the framework. In some cases, the software calls the framework to validate a previously instantiated object and then calls the framework to instantiate another object of the class with additional attributes. The application then transmits the additional attributes for the second object to the framework.

In another implementation, software receives a first call to instantiate a first object based on a class using an associated generic class constructor and receives a second call to instantiate a second object using the associated generic class constructor. This software then receives a first set of additional attributes for the first object and instantiates the first object, the instantiated first object including the first set of additional attributes. In one example, the software may be a static method of setting the additional attributes in the object of the particular class. Thus, static attributes of the particular class are copied to the instantiated object in the framework and each instance of the class contains the same static attributes.

Moreover, some or all of these aspects may be further included in respective systems or other devices for executing, implementing, or otherwise supporting a software application that can create instances of the class within the framework with varying attributes. The details of these and other aspects and embodiments of the disclosure are set forth in the accompanying drawings and the description below. Other features, objects, and advantages of the various embodiments will be apparent from the description and drawings, as well as from the claims.

### DESCRIPTION OF DRAWINGS

FIG. 1 illustrates an example system for the management of object instantiation between a software application and a generic object-oriented framework through a generic data constructor in accordance with certain embodiments included in the present disclosure;

FIG. 2A illustrates the call of the generic data constructor by the software application to the framework in order to instantiate an object of a class in accordance with certain embodiments in the present disclosure;

FIG. 2B illustrates the call of the data constructor by the application as exemplified by a UML sequence diagram in accordance with certain embodiments in the present disclosure;

FIG. 3 illustrates an example software application implementing certain techniques and components in accordance with one embodiment of the system of FIG. 1;

FIG. 4 is an example flowchart illustrating the management of object instantiation using the generic framework through the data constructor in accordance with certain embodiments included in the present disclosure; and

FIG. 5 is an example flowchart illustrating the management of object instantiation from the software application through the constructor in accordance with certain embodiments included in the present disclosure.

### DETAILED DESCRIPTION

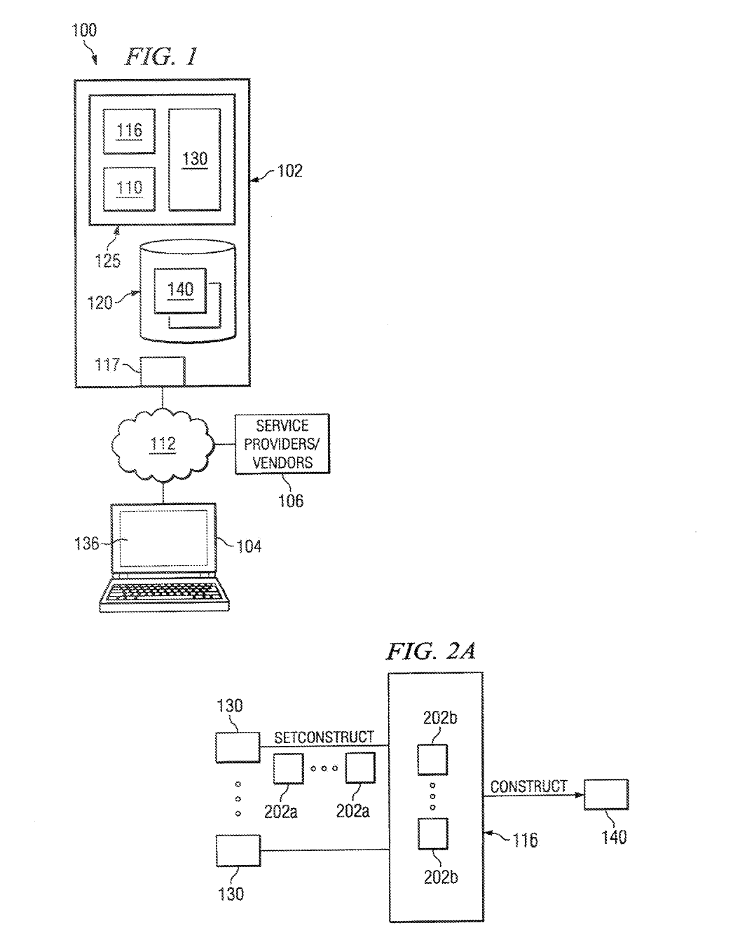

FIG. 1 illustrates an example system 100 for the management of object instantiation between a software application and a generic object-oriented framework through, for example, a generic data constructor. This framework is typically decoupled from (but communicably linked with) the requesting applications and used to outsource the various object-oriented programming functionality. For example, the requesting applications may request instantiated objects from the framework utilizing one or more standard (or generic) constructors. The generic data constructor is, generally, a function, or method, associated with a particular class and utilized to assist the framework in instantiating one or more entities of the class with a set of attributes. Generally, system 100 allows developers to provide increased functionality to business applications 130 by allowing the instantiation of objects of certain classes with consistent instance attributes beyond those provided by the generic constructors. Attributes are generally some data associated with each object, or instance, of the class, and may be located within application 130, as additional attributes, or on framework 116, as predefined attributes. The additional attributes, located within application 130, are transmitted to the framework 116, which instantiates the object with the additional attributes using one of the standard data constructor associate with the standard class. Thus, the instantiated object attributes reflect the predefined attributes of framework 116, as well as the additional attributes of application 130. The task of the developer in creating consistent instances, or objects, of the class through the framework may be made easier by decreasing the development effort and increasing application supportability and simplicity.

Referring to illustrated FIG. 1, the software application 130 resides on a server 102 providing various business processes and functionality to a client 104. The server 102 may be a server controlled by the developer of the system 100, a server controlled by the user of the system 100, or alternatively, a server at a third party providing hosting services. System 100 is typically a distributed client/server system that spans one or more networks such as 112. Also, rather than being delivered as a packaged software, system 100 may represent a hosted solution, often for an enterprise or other small business that may scale cost-effectively and help drive faster adoption. In this case, portions of the hosted solution may be developed by a first entity, while other components are developed by a second entity. These entities may participate in any suitable form of revenue or cost sharing as appropriate. Moreover, the processes or activities of the hosted solution may be distributed amongst these entities and their respective components. In another example, system 100 may implement a component-based architecture and strong platform helping engage service providers to develop targeted solutions for sub-verticals or others types of markets. Further, system 100 may store data (user, transaction, service provider, and such) at a relatively central location (over WAN), while concurrently maintaining local data at the user's site for redundancy and to allow processing during downtime. But system 100 may be in a dedicated enterprise environment—across a local area network (over LAN) or subnet—or any other suitable environment without departing from the scope of this disclosure.

Turning to the illustrated embodiment, system 100 includes or is communicably coupled with server 102, one or more clients 104, and one or more service providers or vendors 106, at least some of which communicate across network 112. Server 102 comprises an electronic computing device operable to receive, transmit, process, and store data associated with system 100. Each computer is generally intended to encompass any suitable processing device. For example, although FIG. 1 illustrates one server 102 that may be used with the disclosure, system 100 can be implemented using computers other than servers, as well as a server pool. Indeed, server 102 may be any computer or processing device such as, for example, a blade server, general-purpose personal computer (PC), Macintosh, workstation, Unix-based computer, or any other suitable device. In other words, the present disclosure contemplates computers other than general purpose computers, as well as computers without conventional operating systems. Server 102 may be adapted to execute an operating system including Linux, UNIX, Windows Server, or any other suitable operating system. According to one embodiment, server 102 may also include or be communicably coupled with a web server and/or a mail server.

Illustrated server 102 includes a local memory 120. Memory 120 may include any memory or database module and may take the form of volatile or non-volatile memory including, without limitation, magnetic media, optical media, random access memory (RAM), read-only memory (ROM), removable media, or any other suitable local or remote memory component. Illustrated memory 120 includes one or more developed objects 140. But memory 120 may also include any other appropriate data such as VPN applications or services, firewall policies, a security or access log, print or other reporting files, HTML files or templates, data classes or object interfaces, child software applications or sub-systems, and others.

Illustrated server 102 also includes a processor 125. Processor 125 executes instructions and manipulates data to perform the operations of server 102. Processor 125 is, for example, a central processing unit (CPU), a blade, an application specific integrated circuit (ASIC), or a field-programmable gate array (FPGA). Although FIG. 1 illustrates a single processor 125 in server 102, multiple processors 125 may be used according to particular needs and reference to processor 125 is meant to include multiple processors 125 where applicable. In the illustrated embodiment, processor 125 executes software application 130.

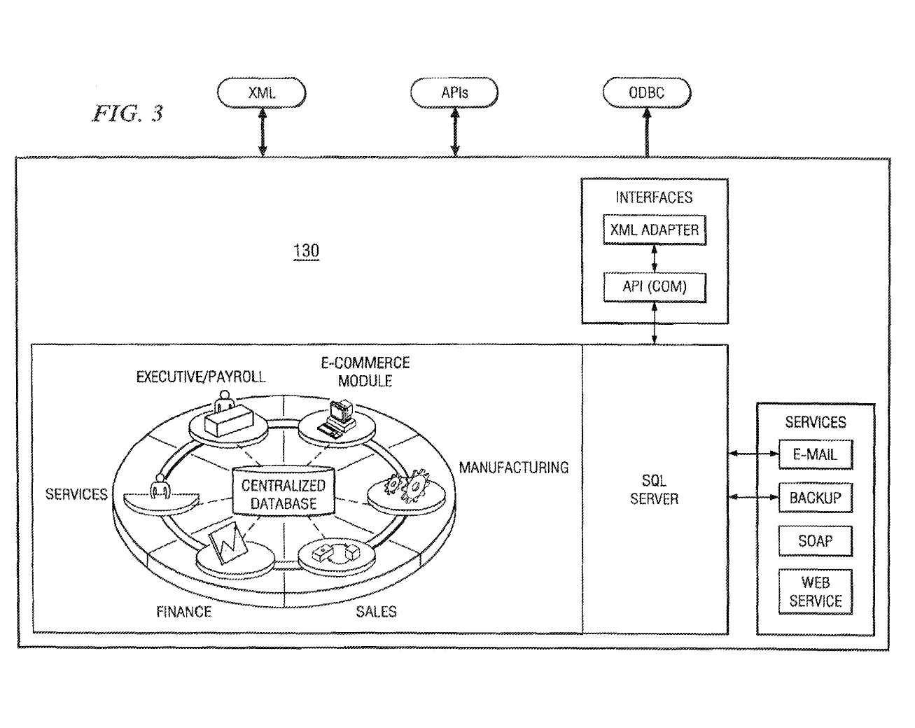

At a high level, application 130 is any application, program, module, process, or other software that may utilize, change, delete, generate, or is otherwise associated with the developed objects 140 according to the present disclosure. In certain cases, system 100 may implement a composite application 130, as described in FIG. 3. Regardless of the particular implementation, software may include software, firmware, wired or programmed hardware, or any combination thereof as appropriate. Indeed, application 130 may be written or described in any appropriate computer language including C, C++, Java, Visual Basic, assembler, Perl, any suitable version of 4GL, as well as others. For example, portions of the composite application may be implemented as Enterprise Java Beans (EJBs) or design-time components may have the ability to generate run-time implementations into different platforms, such as J2EE (Java 2 Platform, Enterprise Edition), ABAP (Advanced Business Application Programming) objects, or Microsoft's .NET. It will be understood that, while application 130 is illustrated in FIG. 3 as including numerous sub-modules, application 130 may instead be a single multi-tasked module that implements the various features and functionality through various objects, methods, or other processes. Further, while illustrated as internal to server 102, one or more processes associated with application 130 may be stored, referenced, or executed remotely. For example, a portion of application 130 may be a web service that is remotely called, while another portion of application 130 may be an interface object bundled for processing at remote client 104. Moreover, application 130 may be a child or sub-module of another software module or enterprise application (not illustrated) without departing from the scope of this disclosure. Indeed, application 130 may be a hosted solution that allows multiple parties in different portions of the process to perform the respective processing. For example, client 104 may access application 130, once developed, on server 102 or even as a hosted application located at service provider/vendor 106 over network 112 without departing from the scope of this disclosure. In another example, portions of software application 130 may be developed by the developer working directly at server 102, as well as remotely at client 104.

More specifically, as illustrated in FIG. 3, application 130 may be a composite application, or an application built on other applications, that includes an object access layer (OAL) and a service layer. In this example, application 130 may execute or provide a number of application services, such as customer relationship management (CRM) systems, human resources management (HRM) systems, financial management (FM) systems, project management (PM) systems, knowledge management (KM) systems, and electronic file and mail systems. Such an object access layer is operable to exchange data with a plurality of enterprise base systems and to present the data to a composite application through a uniform interface. The example service layer is operable to provide services to the composite application. These layers may help composite application 130 to orchestrate a business process in synchronization with other existing processes (e.g., native processes of enterprise base systems) and leverage existing investments in the IT platform. Further, composite application 130 may run on a heterogeneous IT platform. In doing so, composite application 130 may be cross-functional in that it may drive business processes across different applications, technologies, and organizations. Accordingly, composite application 130 may drive end-to-end business processes across heterogeneous systems or sub-systems. Application 130 may also include or be coupled with a persistence layer and one or more application system connectors. Such application system connectors enable data exchange and integration with enterprise sub-systems and may include an Enterprise Connector (EC) interface, an Internet Communication Manager/Internet Communication Framework (ICM/ICF) interface, an Encapsulated PostScript (EPS) interface, and/or other interfaces that provide Remote Function Call (RFC) capability. It will be understood that while this example describes the composite application 130, it may instead be a standalone or (relatively) simple software program. Regardless, application 130 may also perform processing automatically, which may indicate that the appropriate processing is substantially performed by at least one component of system 100. It should be understood that this disclosure further contemplates any suitable administrator or other user interaction with application 130 or other components of system 100 without departing from its original scope.

Processor 125 may also execute a development environment 110, which generally is any software application designed to help develop software application 130 (as well as any related components, modules, and such) for clients 104 or other third-parties. Further, development environment 110 allows a developer to develop, update, etc., applications or objects. Although development environment 110 is illustrated in FIG. 1 as residing on server 102, this aspect may also reside on a server located at, or controlled by service providers/vendors 106. Further, development environment 110 may be located on a server located at, or controlled, by any other third party. As another example, development environment 110 may reside on server 102 but still be accessible to service providers/vendors 106 or other third parties. In another example, development environment 110 may be accessed by the developer from server 1.02, as well as from client 104.

Illustrated processor 125 also includes a framework 116, which generally unifies portions of software code to reduce development efforts and code maintenance. More specifically, framework 116 may be an object-oriented generic framework that instantiates one or more objects, or entities, using a generic data, or class constructor. Once instantiated by framework 116, objects may be developed objects 140 residing in memory 120. Further, framework 116 may receive one or more calls from application 130 to instantiate objects with the set of predefined attributes located on framework 116. In addition to instantiating the object with the set of predefined attributes, framework 116 may receive a set of additional attributes from application 130, which are also set as instance attributes of the instantiated object. This helps ensure that the instantiated object is consistent, i.e. the attributes of the object reflect the additional attributes located in application 130.

In another embodiment, the generic constructor of the class sought to be instantiated may ensure that a previous call to the framework 116 to instantiate the object of the class was performed correctly. In this embodiment, a correct instantiation of the object occurs when the attributes of the instantiated object are consistent with predefined attributes located on framework 116, as well as additional attributes located on application 130.

Server 102 may also include an interface 117 for communicating with other computer systems, such as clients 104, over network 112 in a client-server or other distributed environment. In certain embodiments, server 102 receives data from internal or external senders through interface 117 for storage in memory 120 and/or processing by processor 125. Generally, interface 117 comprises logic encoded in software and/or hardware in a suitable combination and operable to communicate with network 112. More specifically, interface 117 may comprise software supporting one or more communications protocols associated with communications network 112 or hardware operable to communicate physical signals.

Network 112 facilitates wireless or wireline communication between computer server 102 and any other local or remote computer, such as clients 104. Network 112 may be all or a portion of an enterprise or secured network. In another example, network 112 may be a VPN merely between server 102 and client 104 across wireline or wireless link. Such an example wireless link may be via 802.11a, 802.11b, 802.11g, 802.11n, 802.20, WiMax, and many others. While illustrated as a single or continuous network, network 112 may be logically divided into various sub-nets or virtual networks without departing from the scope of this disclosure, so long as at least portion of network 112 may facilitate communications between server 102 and at least one client 104. In another example, some vendors 106 may represent local vendors 106, which physically interact with client 104 without the use of network 112. In other words, network 112 encompasses any internal or external network, networks, sub-network, or combination thereof operable to facilitate communications between various computing components in system 100. Network 112 may communicate, for example, Internet Protocol (IP) packets, Frame Relay frames, Asynchronous Transfer Mode (ATM) cells, voice, video, data, and other suitable information between network addresses. Network 112 may include one or more local area networks (LANs), radio access networks (RANs), metropolitan area networks (MANs), wide area networks (WANs), all or a portion of the global computer network known as the Internet, and/or any other communication system or systems at one or more locations. In certain embodiments, network 112 may be a secure network associated with the enterprise and certain remote clients 104.

Client 104 is any computing device operable to connect or communicate with server 102 or network 112 using any communication link. At a high level, each client 104 includes or executes at least GUI 136 and comprises an electronic computing device operable to receive, transmit, process, and store any appropriate data associated with system 100. While not illustrated here, client 104 typically includes local memory or is coupled with some relatively remote or distributed memory that may be quickly accessed. It will be understood that there may be any number of clients 104 communicably coupled to server 102. Further, “client,” “business,” and “user” may be used interchangeably as appropriate without departing from the scope of this disclosure. Moreover, for ease of illustration, each client 104 is described in terms of being used by one user. But this disclosure contemplates that many users may use one computer or that one user may use multiple computers. In certain situations, users may include owners, bookkeepers, as well as third party or outside accountants.

As used in this disclosure, client 104 is any person, department, organization, small business, enterprise, or any other entity that may use or request others to use system 100, namely, application 130. For simplicity, client 104 may encompass a personal computer, touch screen terminal, workstation, network computer, kiosk, wireless data port, smart phone, personal data assistant (PDA), one or more processors within these or other devices, or any other suitable processing device used by or for the benefit of client 104. For example, client 104 may be a PDA operable to wirelessly connect with an external or unsecured network. In another example, client 104 may comprise a laptop that includes an input device, such as a keypad, touch screen, mouse, or other device that can accept information, and an output device that conveys information associated with the operation of server 102 or clients 104, including digital data, visual information, or GUI 136. Both the input device and output device may include fixed or removable storage media, such as a magnetic computer disk, CD-ROM, or other suitable media to both receive input from and provide output to users of clients 104 through the display, namely, the client portion of GUI or application interface 136.

GUI 136 comprises a graphical user interface operable to allow the user of client 104 to interface with at least a portion of system 100 for any suitable purpose, such as viewing application or other transaction data. Generally, GUI 136 provides the particular user with an efficient and user-friendly presentation of data provided by or communicated within system 100. GUI 136 may comprise a plurality of customizable frames or views having interactive fields, pull-down lists, and buttons operated by the user. For example, GUI 136 is operable to display certain developed objects 140 in a user-friendly form based on the displayed data. GUI 136 may also present a plurality of portals or dashboards. For example, GUI 136 may display a portal that allows users to view, create, and manage historical and real-time reports, including role-based reporting and such. Generally, historical reports provide critical information on what has happened, including static or canned reports that require no input from the user and dynamic reports that quickly gather run-time information to generate the report. Of course, reports may be in any appropriate output format including PDF, HTML, and printable text. Real-time dashboards often provide table and graph information on the current state of the data, which may be supplemented by business objects. GUI 136 is often configurable, supporting a combination of tables and graphs (bar, line, pie, status dials, etc.), and is able to build real-time dashboards, where developed object 140 (as well the displayed application or transaction data) may be relocated, resized, and such. It should be understood that the term graphical user interface may be used in the singular or in the plural to describe one or more graphical user interfaces and each of the displays of a particular graphical user interface. Indeed, reference to GUI 136 may indicate a reference to the front-end or a component of application 130, as well as the particular interface accessible via client 104, as appropriate, without departing from the scope of this disclosure. Therefore, GUI 136 contemplates any graphical user interface, such as a generic web browser or touch screen that processes information in system 100 and efficiently presents the results to the user. Server 102 can accept data from client 104 via the web browser (e.g., Microsoft Internet Explorer or Netscape Navigator) and return the appropriate HTML or XML responses to the browser using network 112.

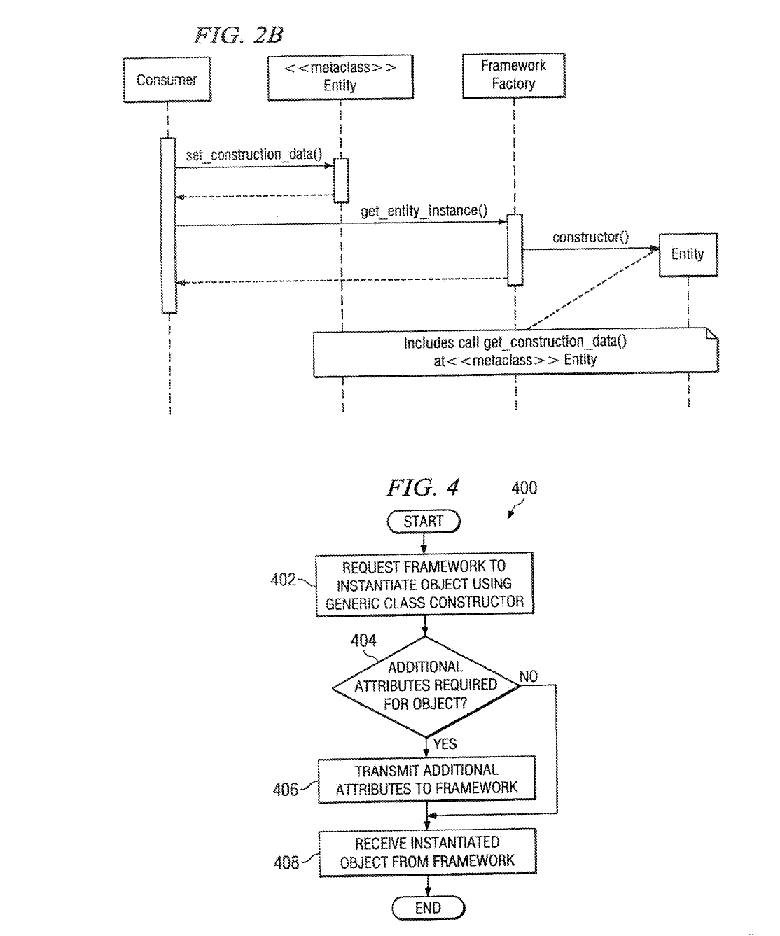

FIG. 2A depicts the call of the data constructor by the application 130 to framework 116 in order to instantiate an object of the class, in accordance with certain embodiments in the present disclosure. As illustrated, one or more applications 130 may interact with framework 116, which instantiates abstract entities, or objects, with a predefined set of instance attributes 202b, i.e., attributes stored within the framework 116. However, as contemplated by the disclosure, one or more applications 130 may require that objects be instantiated with additional attributes 202a residing outside of framework 116. As illustrated in FIG. 2A, application 130 transmits a SET CONSTRUCT call to framework 116, thus requesting the framework to instantiate the object for application 130. The application 130 further sends one or more additional attributes 202a to framework 116 in order for the object to be instantiated with these additional attributes. Framework 116 performs a CONSTRUCT method, thereby instantiating the object with both predefined attributes 202b, as well as additional attributes 202a. Upon instantiation with the correct instance attributes, the object may become developed object 140 residing in memory 120. Further, developed object 140 may be communicated from server 102 to one or more clients 104 or even one or more service providers/vendors 106 across network 112. Developed object 140 may also remain on server 102 but be accessible to one or more clients 104 or service providers/vendors 106.

FIG. 2B describes the call of the data constructor by application 130 as exemplified by a UML sequence diagram, in accordance with certain embodiments in the present disclosure. As illustrated, consumer 252 makes a set_construction_data( ) call to the framework factory 116 to instantiate an instance of the <<metaclass>> Entity 254. Consumer 252, as shown here, may operate as application 130 for the purposes of this example. As depicted in FIG. 2B, the <<metaclass>> Entity 254 identifies a class and not an instance, or object, of this class. The call set_construction_data( ) provides the framework factory 116 with additional attributes from consumer 252, thus allowing the framework factory 116 to instantiate the object of the class Entity 254 with both predefined and additional attributes. As shown, framework factory 116 instantiates the object by invoking method constructor( ), which also includes the call get_construction_data( ) at <<metaclass>> Entity 254. This call gathers the predefined attributes located on framework factory 116 in order to instantiate the object of <metaclass>> Entity 254 with both predefined and additional attributes. Once instantiated, the object of <<metaclass>> Entity 254 is returned to consumer 252 through a get entity instance( ) call. As described in accordance with FIG. 2B, <<metaclass>> Entity 254 may be any appropriate class in which consumer 252 requests instances. The description of <<metaclass>> Entity 254 is, therefore, of the class itself and not an instance of the class, i.e., the calls to this class are static and attributes are shared by all instances, or objects, of the class.

FIG. 4 illustrates an example method 400 for managing object instantiation using the generic framework through the data constructor. In step 402, application 130 requests framework 116 to instantiate an object of a particular class using the generic data constructor. In step 404, application 130 determines whether the object to be instantiated requires additional attributes. If no such additional attributes are required, application 130 receives the instantiated object of the particular class set with predefined attributes located on framework 116, as shown in step 408. However, if application 130 includes additional attributes required in the instantiated object, application 130 transmits these additional attributes to framework 116, as illustrated in step 406. In step 408, application 130 receives an instantiated object of the particular class, which includes both predefined attributes located on framework 116, as well as additional attributes residing on application 130.

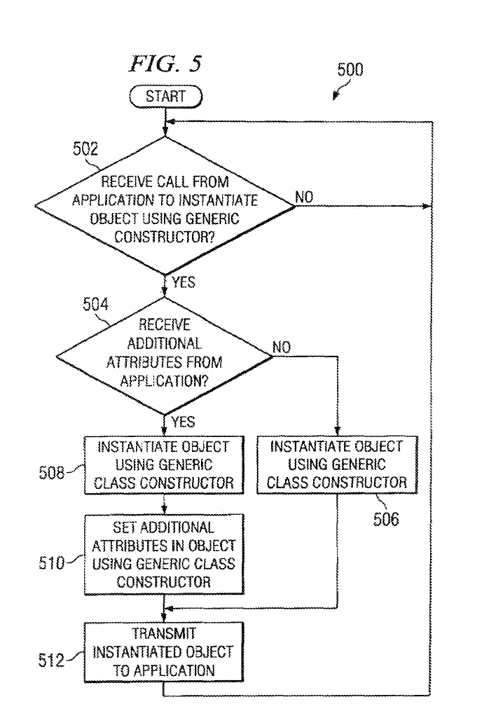

FIG. 5 illustrates an example method 500 for the management of object instantiation from the software application through the generic data constructor. In step 502, the framework 116 receives a call from application 130 to instantiate an object of a particular class. Next, as shown in step 504, the framework 116 may receive a set of additional attributes from application 130 to be included in the instantiated object. If no set of additional attributes from application 130 is received, the framework 116 utilizes the generic data constructor to instantiate the object of the particular class, as illustrated in step 506. The generic data constructor instantiates the object with the set of predefined attributes in framework 116. Should framework 116 receive the set of additional attributes from application 130, the object of the particular class requested by application 130 is still instantiated by the generic class constructor on framework 116, shown in step 508. However, following this instantiation, the additional attributes received from application 130 are set in the instantiated object in step 510. As illustrated in step 512, framework 116 transmits the instantiated object, including both predefined and additional attributes as appropriate, to application 130. Once framework 116 transmits the instantiated object to application 130, it awaits a next call from application 130.

It will be understood that these methods are for illustration purposes only and that the described or similar processes and techniques may be performed at any appropriate time, including concurrently, individually, or in combination. In addition, many of the steps in this flowchart may take place simultaneously and/or in different orders than as shown. For example, the framework 116 may receive additional attributes from application 130 subsequent to or concurrent to instantiating the object. Moreover, system 100 may use or implement similar methods with additional steps, fewer steps, and/or different steps, so long as the methods remain appropriate. For example, framework 116 may receive calls from one or more applications 130 to instantiate one or more objects. Upon receiving a second call, framework 116 may receive yet another set of additional attributes from application 130. In this manner, framework 116 may instantiate another object with the second set of additional attributes. Of course, framework 116 may instantiate the object of the particular class using the generic data constructor without setting additional attributes. Finally, framework 116 may instantiate one or more objects, with each object being an instance of a separate class.

In another example of a similar method, application 130 may request framework 116 to validate the object previously instantiated with additional attributes. Upon such a request, framework 116 utilizes the generic class constructer to validate the previously instantiated object, i.e. confirm that the attributes in the instantiated object match the additional attributes in application 130.

Although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the scope of this disclosure.

What is claimed is:

1. Software for managing object instantiation using a generic framework, the software comprising computer readable instructions operable when executed to:
request the framework to instantiate a first object using a generic class constructor;
transmit a first set of additional attributes for the first object to the framework; and
receive an instantiated first object from the framework, the instantiated first object including the first set of additional attributes.

2. The software of claim 1 further operable to:
request the framework to instantiate a second object with the generic class constructor;
transmit a second set of additional attributes for the second object to the framework; and
receive an instantiated second object from the framework, the instantiated second object including the second set of additional attributes.

3. The software of claim 1, wherein the first set of additional attributes are static.

4. The software of claim 1 further operable to:
make a first call to the framework to validate the instantiated first object;
make a second call to the framework to instantiate a second object; and
transmit a second set of additional attributes for the second object to the framework.

5. The software of claim 1 further operable to:
receive a first request from a client to call the framework to instantiate the first object;
receive a second request from the client to call the framework to instantiate a second object; and
transmit the instantiated first object to the client.

6. Software for managing object instantiation from an application, the software comprising computer readable instructions operable when executed to:
receive a first call to instantiate a first object based on a class using an associated generic class constructor;
receive a second call to instantiate a second object using the associated generic class constructor;
receive a first set of additional attributes for the first object; and
instantiate the first object, the instantiated first object including the first set of additional attributes.

7. The software of claim 6, wherein the first set of additional attributes is set statically in the first object.

8. The software of claim 6 further operable to:
receive a first request from the application to validate the first instantiated object;
validate the first instantiated object;
receive a second set of additional attributes for the second object; and
instantiate the second object, the instantiated second object including the second set of additional attributes.

9. The software of claim 6, the first call from a first application.

10. The software of claim 9 further operable to transmit the instantiated first object to the first application.

11. The software of claim 9, the second call from a second application.

12. The software of claim 11 further operable to:
receive a second set of additional attributes; and
instantiate the second object, the instantiated second object including the second set of additional attributes.

13. The software of claim 9, the second call from the first application, and the software further operable to:
receive a second set of additional attributes; and
instantiate the second object, the instantiated second object including the second set of additional attributes.

14. The software of claim 13, the first and second instantiated objects based on a first class, and the software further operable to:
receive a third call to instantiate a third object based on a second class using an associated generic class constructor;
receive a third set of additional attributes for the third object; and
instantiate the third object, the instantiated third object including the third set of additional attributes.

15. A system for managing object instantiation using a generic framework, comprising:
means for requesting the framework to instantiate a first object using a generic class constructor;
means for transmitting a first set of additional attributes for the first object to the framework; and
means for receiving an instantiated first object from the framework, the instantiated first object including the first set of additional attributes.

16. A system for managing object instantiation from an application, comprising:
means for receiving a first call to instantiate a first object based on a class using an associated generic class constructor and a second call to instantiate a second object using the associated generic class constructor;
means for receiving a first set of additional attributes for the first object; and
means for instantiating the first object, the instantiated first object including the first set of additional attributes.
